(19) United States
(12) Patent Application Publication
(10) Pub. No.: US 2026/0334748 A1
(43) Pub. Date: Oct. 29, 2026

(54) PROCESS FOR PRODUCTION OF A MULTILAYER CLOTH PRODUCT

(71) Applicant: DR. SCHUMACHER GMBH, Malsfeld (DE)

(72) Inventors: Jessica POGRZEBA, Malsfeld (DE); Marie-Elisabeth REHM, Malsfeld (DE); Kai-Uwe POHL, Malsfeld (DE); Selina SCHWEINSBERG, Malsfeld (DE); Mike BALLEZ, Malsfeld (DE); Anke BIRKELBACH, Malsfeld (DE); Mina HEIDARI, Malsfeld (DE)

(73) Assignee: DR. SCHUMACHER GMBH, Malsfeld (DE)

(21) Appl. No.: 18/995,937

(22) PCT Filed: Aug. 10, 2023
(86) PCT No.: PCT/EP2023/072187

§ 371 Date: Jan. 17, 2025

(30) Foreign Application Priority Data
Aug. 17, 2022 (WO) PCT/DE2022/100611

(51) Int. Cl. A47L 13/16; B32B 5/02; B32B 5/06; B32B 5/26; B32B 38/00

(52) U.S. Cl. CPC A47L 13/16; B32B 5/022; B32B 5/067; B32B 5/266; B32B 38/0036; B32B 38/164; B32B 2250/03; B32B 2250/20; B32B 2262/04; B32B 2262/065; B32B 2262/144; B32B 2305/20; B32B 2305/70; B32B 2309/02; B32B 2310/028; B32B 2432/00

(57) ABSTRACT

The invention relates to a method for producing a multi-layered cloth product comprising at least a cleaning layer and a core layer, each containing cellulose and/or consisting entirely of natural fibres and/or regenerated fibres, wherein the cleaning layer and the core layer are bonded together by means of hydroentanglement.

The present invention relates to a process for production of multilayer cloth products, in particular multilayer disposable cloth products, such as, for example, disposable floor sweeping cloths.

Depending on their nature, cloth products are used in a wide variety of ways, in particular in the cosmetic and hygienic area, as well as for numerous cleaning applications. Depending on the desired application, which often involves wet or moist conditions, the cloth products can be impregnated with an impregnating agent and packaged individually or in units comprising a predetermined number of cloth products, or they can also be packaged in an unimpregnated state and, if necessary, only be impregnated or moistened after removal from the packaging, if this is desired or necessary.

Depending on the desired application of the cloth products, these may comprise several layers of nonwoven fabric, which may be composed in the same or different ways. In the case of disposable sweeping cloths for cleaning surfaces, it is known that these should comprise several layers of nonwoven fabric, which are usually composed in different ways. On the one hand, this ensures that the sweeping cloth is sufficiently stable and, on the other hand, if layers of nonwoven fabrics having different compositions are selected, it can ensure that, for example, a first layer offers good liquid absorption while a second layer offers good liquid release.

WO02/36339A2, for example, describes such a multilayer pre-impregnated wiping cloth, at least two layers of which contain a mixture of hydrophilic and hydrophobic fibres. Therein, the sweeping cloth comprises at least one cleaning layer as well as one layer that serves as a liquid reservoir.

A similar approach for a multilayer disposable floor sweeping cloth is described in EP1212478A1. An antimicrobial property is conferred to the floor sweeping cloths by the addition of silver particles.

U.S. Pat. No. 4,298,649A describes a multilayer floor sweeping cloth composed of several layers of polypropylene having different appearances, wherein the floor sweeping cloth contains surfactants.

This solution is disadvantageous in that the floor sweeping cloth being a disposable item is not environmentally friendly due to the high plastic content.

A more environmentally friendly alternative is disclosed in WO2018/017597A1, which describes an at least single-layered disposable floor sweeping cloth. The composition of the individual layers is described to be fully compostable and biodegradable. A high PLA content ensures that the individual layers can be welded together.

DE102021122041B3 describes a disposable multi-layer floor sweeping cloth having an abrasive strip, which comprises at least one cleaning layer and one core layer, both of which contain cellulose and consist entirely of natural and/or regenerated fibres, wherein a scraping strip having increased abrasive properties in comparison to the rest of the cleaning layer is arranged on or in the cleaning layer, and wherein the scraping strip contains hemp and also consists entirely of natural and/or regenerated fibres. The cleaning layer and the core layer, as well as optional further layers, are preferably connected to one another by means of micro-entanglement through movement generated by ultrasound.

### OBJECT OF THE INVENTION

It is the object of the present invention to provide an alternative process for production of multi-layer environmentally friendly cloth products, which preferably overcomes the aforementioned disadvantages known from the prior art and is characterized in particular by a firm and chemical-free bonding of the individual layers to one another.

### DETAILED DESCRIPTION OF THE INVENTION

The invention achieves this object with the features of the claims and in particular by providing a process for production of a multi-layer cloth product that comprises at least one cleaning layer and one core layer, each of which contains cellulose and/or consists entirely of natural fibres and/or regenerated fibres, wherein the cleaning layer and the core layer are bonded to one another by means of hydroentanglement.

Optionally, in the process according to the invention, one or more further layers, which also consist entirely of natural fibres and/or regenerated fibres, are also bonded to the cleaning layer and/or the core layer by means of hydroentanglement. Another layer can be, in particular, a top layer that consists entirely of natural and/or regenerated fibres and is bonded to the core layer by means of hydroentanglement on the side facing away from the cleaning layer.

In the context of the present invention, a “cleaning layer” refers to a layer providing good liquid release. This is the layer that directly contacts the surface to be cleaned during use. However, in more abstract terms, the cleaning layer can also be referred to as the “first layer”, which is why “cleaning layer” and “first layer” are used synonymously and interchangeably in the present disclosure.

A “core layer” in the context of the present invention refers to a layer providing good liquid absorption that serves as a storage reservoir for impregnating agents and passes this on to the cleaning layer. However, in more abstract terms, the core layer can also be referred to as a “second layer”, which is why “core layer” and “second layer” are used synonymously and interchangeably in the present disclosure.

In the context of the present invention, a “top layer” refers to a layer that can act as a barrier layer. This additional layer can be arranged in particular on the side of the core layer facing away from the cleaning layer, where it ensures that liquid is not released upwards but only downwards. The top layer can also be referred to as a “third layer”, which is why “top layer” and “third layer” are used synonymously and interchangeably in the context of the present disclosure.

According to the invention, the cleaning layer, the core layer, the optional top layer and other optional layers contain natural fibres and/or regenerated fibres. “Natural fibres” are understood to mean all fibres of natural origin that can be used directly without further chemical conversion reactions. “Regenerated fibres”, on the other hand, are fibres that are produced from naturally occurring, renewable raw materials using chemical processes. However, like natural fibres, regenerated fibres also consist of 100% natural material.

In the prior art, hydroentanglement is known only for reinforcing individual and loose fibres, respectively, i.e. it is known that nonwoven fabrics can be produced by hydroentanglement. However, it has now been surprisingly discovered in the context of the present invention that hydroentanglement can also be used to bond already reinforced nonwoven fabrics to one another.

The term “nonwoven fabrics” refers to reinforced materials made of fibres in which the fibres have already formed a strong bond. Since hydroentanglement normally involves a loose fibre web being hooked together by the water jets and thus reinforced, one would not expect that hydroentanglement can also be used to bond nonwoven fabrics that have already been reinforced, since there are no longer enough loose fibre ends in these that are not already hooked to other fibres.

However, experiments were carried out to determine the suitability of ultrasonic bonding, needle punching and hydroentanglement for joining layers of reinforced nonwoven fabrics. These experiments showed that hydroentanglement is actually the most suitable method.

In the case of ultrasonic bonding, the problem had to be addressed that ultrasonic frequencies generate heat, which leads to a thermal bonding of the fibres. However, in the absence of a thermoplastic polymer, this heat does not lead to melting and thus to a bonding. Therefore, attempts were made to enable a better bonding by moistening the core layer. However, this was only partially successful, because although hydrogen bonds between the cellulose-containing layers were formed due to the introduced water molecules, these hydrogen bonds broke down again on contact with an impregnation solution, so that the cloth lost its structural integrity.

Another approach was to join the cleaning layer, the core layer and a top layer by needle punching. Needle punching is a process in which needles are pushed through the fabric, transporting the fibres from the top to the bottom side. This connects the fibres and mechanically reinforces the fabric. In the present case, however, it was found that the core layer was severely damaged by the needle punching and knobs formed on the “punctured side”. Nevertheless, different compositions were chosen for the individual nonwoven layers, which were to be bonded by needling. However, either an adequate bond could not be achieved, or the resulting cloth had extremely poor sliding properties, which is why it was completely unsuitable for cleaning surfaces and especially for floor sweeping cloths.

With hydroentanglement, on the other hand, excellent bondings having high resilience and stability, even in contact with impregnating agents, could be produced between the already highly reinforced nonwoven fabrics that made up the individual layers.

The process according to the invention for producing a multi-layer cloth product is therefore characterized in that the cleaning layer and the core layer, as well as optionally one or more further layers, in particular the top layer, are produced in that for each of these layers independently of one another the fibres of which it was made are processed into a nonwoven fabric, i.e. reinforced, and the cleaning layer, the core layer and optionally one or more further layers are thus obtained in each case as a separate nonwoven fabric, and wherein the (reinforced) nonwoven fabrics obtained in this way, which are the cleaning layer, the core layer and optionally one or more further layers, in particular the top layer, are then bonded to one another by means of hydroentanglement.

According to one embodiment, the fibres that are contained in the cleaning layer, the core layer and/or the further layer are bonded to form a nonwoven fabric by manufacturing technologies that belong to the “web formation” technology or to the “web bonding” technology. Preferred processes belonging to the “web formation” technology are carding, airlaid, wetlaid, meltblown and spunlaid. Preferred processes belonging to the “web bonding” technology, on the other hand, are calendering, hydroentanglement, spunlace, needle punch and air through bonding.

According to a preferred embodiment of the process according to the invention, the cleaning layer is produced by bonding/reinforcing hemp fibres and viscose fibres to form a nonwoven fabric, wherein the proportion of hemp fibres is preferably equal to or greater than the proportion of viscose fibres. Advantageously, the proportion of hemp fibres is about 50-70 wt. % and the proportion of viscose fibres is about 30-50 wt. %. A preferred basis weight of the cleaning layer is 40-60 g/m² and, more preferably, 50 g/m².

According to a further preferred embodiment of the process according to the invention, the core layer is produced by bonding/reinforcing cellulose fibres, lyocell fibres and/or pulp, optionally with a bio-based binder and/or further plant fibres, to form a nonwoven fabric. For example, it is possible to use only cellulose fibres as the core layer, in the presence of a bio-based binder, and to reinforce them by means of an airlaid process to form a nonwoven fabric. Especially, this has a basis weight of approximately 120-140 g/m². Alternatively, it is also possible, for example, to reinforce pulp and lyocell fibres in a nonwoven fabric using a wetlaid process, with the proportion of pulp being particularly 65-85 wt. % and the proportion of lyocell fibres being correspondingly 15-35 wt. %. Core layers made of pulp/lyocell preferably have a basis weight of about 50-70 g/m². Alternatively, it is also possible, for example, to use further plant fibres to produce the core layer. In particular, this also applies to hemp fibres, which, however, also belong to the already mentioned cellulose fibres.

Optionally, in the process according to the invention, in addition to the cleaning layer and the core layer, a further layer consisting exclusively of viscose fibres is produced by combining the viscose fibres into a nonwoven fabric. This layer preferably functions as a top layer.

According to a preferred embodiment, in the process according to the invention nonwoven fabric layers having the following compositions are produced (data in wt. %):
top layer: 100% viscose
cleaning layer: 70% hemp/30% viscose
core layer: 100% airlaid cellulose, biobased binder

According to a further preferred embodiment, in the process according to the invention nonwoven fabric layers having the following compositions are produced (data in wt. %):
top layer: 100% viscose
cleaning layer: 70% hemp/30% viscose
core layer: 80% pulp, 20% lyocell

According to a further preferred embodiment, in the process according to the invention nonwoven fabric layers having the following compositions are produced (data in wt. %):
top layer: 100% viscose
cleaning layer: 100% CAC (carded/airlaid/carded) cellulose
core layer: 100% airlaid cellulose, biobased binder

According to a further preferred embodiment, in the process according to the invention nonwoven fabric layers having the following compositions are produced (data in wt. %):
top layer: 100% viscose
cleaning layer: 50% hemp, 50% viscose
core layer: 100% airlaid cellulose, biobased binder

According to a further preferred embodiment, in the process according to the invention nonwoven fabric layers having the following compositions are produced (data in wt. %):
top layer: 100% viscose
cleaning layer: 100% viscose
core layer: 100% airlaid cellulose, bio-based binder

It is noteworthy in this context that even formulations comprising 100% cellulose and viscose in the cleaning layer, respectively, provide excellent lubricity of the cloth product, provided that it has a 3D embossing. Without embossing, it has always been necessary for hemp to be included in the cleaning layer until now to ensure sufficient lubricity. However, it was found that a cleaning layer made of pure cellulose and viscose, respectively, shows at least equivalent lubricity if the cloth product has an embossing.

Preferably, the cleaning layer, the core layer and optionally one or more further layers are hydroentangled in a device which has at least two drums, in which the layers to be bonded are treated with water jets, wherein the water jets in the first drum act on the layers to be bonded at a lower pressure than in the second drum.

Preferably, the water jets in the first drum emerge from a plurality of nozzle strips, each nozzle strip in the first drum comprising a plurality of nozzles, wherein the water jets from each nozzle belonging to the same nozzle strip emerge at the same pressure and wherein the pressures of the water jets emerging from nozzles belonging to different nozzle strips may be the same or different and in each case lie between 10 and 80 bar. Preferably, there are three nozzle strips in the first drum, wherein the pressure at which the water jets emerge from the nozzles of the first nozzle strip is preferably between 10 and 30 bar, wherein the pressure at which the water jets emerge from the nozzles of the second nozzle strip, preferably lies between 30 and 60 bar, and wherein the pressure at which the water jets emerge from the nozzles of the third nozzle strip, preferably lies between 60 and 80 bar.

It is also preferred that the water jets in the second drum emerge from a plurality of nozzle strips, wherein each nozzle strip in the second drum comprises a plurality of nozzles, wherein the water jets emerge from each nozzle belonging to the same nozzle strip at the same pressure and wherein the pressures of the water jets emerging from nozzles belonging to different nozzle strips may be the same or different and are each between 30 and 100 bar, preferably between 60 and 100 bar, more preferably between 90 and 100 bar.

Optionally, the second drum has a knobbed structure, in particular a 2D knobbed structure, in order to achieve an embossing of the cloth product that causes improved sliding.

As a result of the hydroentanglement of the cleaning layer, the core layer and optionally one or more further layers, these are bonded to one another and the multi-layer cloth product is obtained. This is then optionally dried at temperatures above 150° C., in particular at temperatures above 170° C. and particularly preferably at temperatures between 175 and 200° C. The drying step is preferably carried out in a multi-drum dryer in which the multi-layer cloth product is not only dried but also pressed. Alternatively or in addition to the aforementioned drying at temperatures above 150° C., the drying step may also involve the application of ultrasound to the cloth product, which is dried by the resulting kinetic energy.

The features of the invention disclosed in the above description, in the examples and in the claims may be essential, both individually and in any combination, for the realization of the invention in its various embodiments.

What is claimed is:

1. A process for production of a multi-layer cloth product, which comprises at least one cleaning layer and one core layer, each of which contains cellulose and/or consists entirely of natural fibres and/or regenerated fibres, wherein the cleaning layer and the core layer are bonded to one another by means of hydroentanglement, wherein the hydroentanglement of the cleaning layer with the core layer and optionally one or more further layers is carried out in a device which has at least two drums in which the layers to be joined are treated with water jets, wherein the water jets in the first drum act on the layers to be joined at a lower pressure than in the second drum.

2. The process for production of a multi-layer cloth product according to claim 1, wherein one or more optional further layers, which also consist entirely of natural fibres and/or regenerated fibres, are also bonded to the cleaning layer and/or to the core layer by means of hydroentanglement.

3. The process for production of a multi-layer cloth product according to claim 1, wherein the cleaning layer and the core layer and optionally one or more further layers are produced in that for each layer the fibres of which it is composed are processed to form a nonwoven fabric, and thus the cleaning layer, the core layer and optionally one or more further layers are obtained as a nonwoven fabric, and wherein the nonwoven fabrics thus obtained, which are the cleaning layer, the core layer and optionally one or more further layers, are then bonded to one another by means of hydroentanglement.

4. The process for production of a multi-layer cloth product according to claim 1, wherein the cleaning layer is produced by combining hemp fibres and viscose fibres to form a nonwoven fabric, with the proportion of hemp fibres being larger than the proportion of viscose fibres.

5. The process for production of a multi-layer cloth product according to claim 1, wherein the core layer is produced by combining cellulosic fibres, lyocell fibres and/or pulp, optionally with a biobased binder and/or further plant fibres, to form a nonwoven fabric.

6. The process for production of a multi-layer cloth product according to claim 1, wherein, in addition to the cleaning layer and the core layer, a further layer consisting exclusively of viscose fibres is produced by combining the viscose fibres into a nonwoven fabric.

7. The process for production of a multi-layer cloth product according claim 1, wherein the fibres comprising the cleaning layer, the core layer and/or the further layer are bonded to form a nonwoven fabric by processes selected independently of one another from the group comprising air-laid processes, wet-laid processes, hydroentanglement, carding, calendering, melt-blown processes, spun-laid processes, air-through bonding, needle punching, spun-bonding processes and DRC processes.

8. (canceled)

9. The process for production of a multi-layer cloth product according to claim 1, wherein the water jets emerge from a plurality of nozzle strips in the first drum, each nozzle strip in the first drum having a plurality of nozzles, wherein the water jets from each nozzle belonging to the same nozzle strip emerge at the same pressure and wherein the pressures of the water jets emerging from nozzles belonging to different nozzle strips may be the same or different and in each case lie between 10 and 80 bar.

10. The process for production of a multi-layer cloth product according to claim 1, wherein the water jets in the second drum emerge from a plurality of nozzle strips, each nozzle strip in the second drum having a plurality of nozzles, wherein the water jets from each nozzle belonging to the same nozzle strip emerge at the same pressure and wherein the pressures of the water jets emerging from nozzles belonging to different nozzle strips may be the same or different and in each case lie between 30 and 100 bar.

11. The process for production of a multi-layer cloth product according to one of the claim 1, wherein the cleaning layer, the core layer and optionally one or more further layers are bonded to one another as a result of the hydroentanglement and the multi-layer cloth product is obtained.

12. The process for production of a multi-layer cloth product according to claim 11, wherein the multi-layer cloth product is subsequently dried at temperatures above 150° C. and/or by ultrasound.

13. The process for production of a multi-layer cloth product according to claim 12, wherein the drying step is carried out in a multi-drum dryer in which the multilayer cloth product is dried and pressed.
